(19) United States
(12) Patent Application Publication
(10) Pub. No.: US 2002/0169790 A1
(43) Pub. Date: Nov. 14, 2002

(54) Kiosk system centrally controlled through internet

(76) Inventor: Jong Myung Lee, Seoul (KR)

Correspondence Address: PENNIE AND EDMONDS, 1155 AVENUE OF THE AMERICAS, NEW YORK, NY, 100362711

(21) Appl. No.: 10/164,794

(22) Filed: Oct. 24, 2001

(30) Foreign Application Priority Data
Oct. 24, 2000 (KR) 2000-62665
Jul. 27, 2001 (KR) 2001-45552
Jul. 27, 2001 (KR) 2001-45553
Jul. 27, 2001 (KR) 2001-45554
Jul. 27, 2001 (KR) 2001-45555

(51) Int. Cl. G06F 7/00

(52) U.S. Cl. 707/104.1

(57) ABSTRACT

A kiosk system centrally controlled through the Internet includes a database for storing public information and advertisement image, a server for reading the public information and the advertisement image stored in the database according to a preset timing schedule and transmitting them through the Internet, and a plurality of kiosks for receiving the public information and the advertisement image from the server through the Internet, a broadcast signal through wireless channels from broadcasting stations, and displaying the advertisement image together with the broadcasting image such that the advertisement image is movably floating along a preset path on the broadcasting image.

### BACKGROUND OF THE INVENTION

1. Field of the Invention

The present invention relates to a kiosk system, and more particularly to a kiosk system for centrally controlling a plurality of kiosks through a public network such as Internet.

2. Description of the Prior Art

Typically, kiosks are installed public places such as bus terminals, airports, and etc. where the public is gathered so as to provide public with various information such as travel information, commercial advertisement, and etc.

However, the conventional kiosks are limited in that they can perform very limited functions. For example, the conventional kiosks may simultaneously provide television broadcasting and public information-providing services, commercial advertisement and public information-providing services, Internet access, or only public information-providing service.

### SUMMARY OF THE INVENTION

The present invention has been made in an effort to solve the above problems.

It is an object of the present invention to provide a kiosk system capable of interactively providing users with various information by the kiosks communicating with a server through a public network such as Internet.

It is another object of the present invention to provide a kiosk system capable of remotely controlling the kiosk terminals by a remote central server so as to effectively providing the users with various kinds of functions and services such as commercial advertisement, television broadcasting, VOD advertisement, public information, and Internet access services.

It is still another object of the present invention to provide a kiosk system capable of providing various services on respective display screens such that the commercial advertisement and television broadcasting services are provided on one screen, and VOD advertisement, public information, and Internet access services are provided on at least one other screed.

It is still another object of the present invention to provide a kiosk system capable of displaying a broadcasting image received through wireless channel on a screen of the kiosk together with overlapped motion graphic user interface advertisements, broadcasting channel information, user selectable advertisement, public information, and Internet access information in a predetermined order.

It is still another object of the present invention to provide a kiosk system allowing users to input instructions by adopting touch screen mechanism so as to interactively provide the user with various services.

To achieve the above objects, the kiosk system of the present invention comprises a database for storing public information and advertisement image, a server for reading the public information and the advertisement image stored in the database according to a preset timing schedule and transmitting them through the Internet, and a plurality of kiosks for receiving the public information and the advertisement image from the server through the Internet, a broadcast signal through wireless channels from broadcasting stations, and displaying the advertisement image together with television broadcasting image on a monitor, such that the advertisement image is movably floating along a preset path on the broadcasting image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a kiosk system according to the preferred embodiment of the present invention;

FIG. 2 is a perspective view showing a kiosk of the kiosk system of this invention;

FIG. 3 is a view showing the construction of a data frame transmitted between a server and each kiosk of this invention;

FIGS. 4a to 4d are views showing a divided screen for simultaneously displaying a broadcast program coordinated with an advertisement signal using a screen division process on the advertisement monitor of this invention;

FIG. 5 is a view showing a screen for displaying an advertisement signal overlapped on a broadcast program on an advertisement monitor of this invention; and

FIGS. 6a and 6b are flowcharts showing the operations of the kiosk of this invention.

### DETAILED DESCRIPTION OF THE PREFERRED EMBODIMENTS

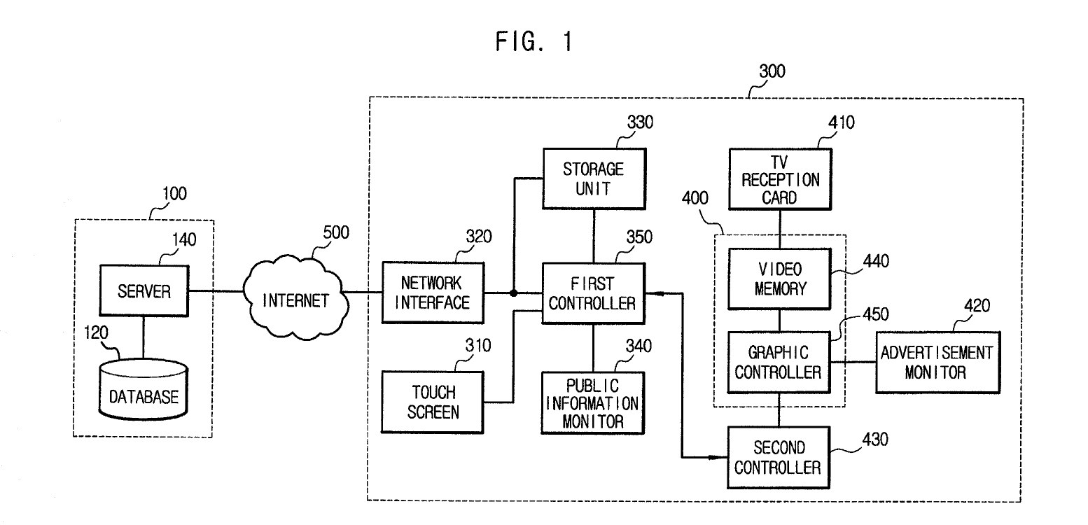

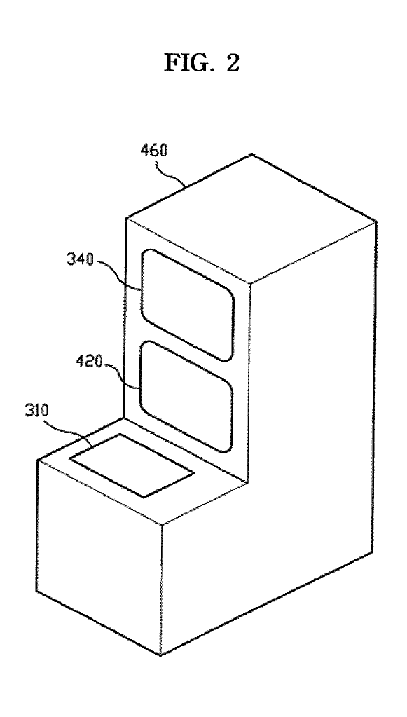

FIG. 1 is a block diagram of a kiosk system according to a preferred embodiment of the present invention, and FIG. 2 is a perspective view showing a kiosk of the kiosk system. Referring to FIG. 1, the kiosk system comprises a server system 100 and a plurality of kiosks 300 communicating with the server system 100 through the Internet 500.

The server system 100 includes a database 120 and a server 400. The database 120 stores a variety of data such as a text files, a video clips, and graphic files for public information, and a plurality of advertisement clips. The server 140 communicates with each kiosk 300 through the Internet 500. The server 140 also transmits the public information and the advertisement clips stored in the database 120 to the kiosk 300 in units of frames. The public information and the advertisement clips can be deleted and updated, and the update information can be displayed on the screen of the kiosk 300 according to a predetermined schedule, for example, in one time per day.

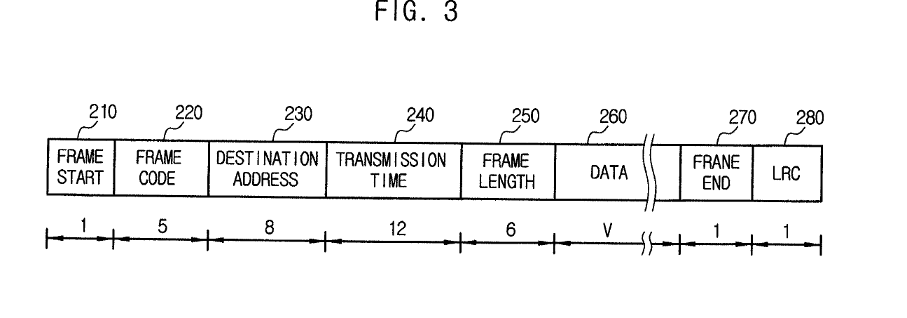

FIG. 3 is a view showing the data frame communicating between the server system 100 and kiosks 300.

Referring to FIG. 3, the data frame consists of frame start field 210, frame code field 220, destination address 230, destination address field 240, transmission time field 250, frame length field 260, data end field 270, and a longitudinal redundancy check (LRC) field 280.

The frame start field 210 is 1 byte and indicates start point of the frame, and the frame code field 220 is 5 bytes and indicates a kind of the frame such as input, output, delete, update, and channel signals. The destination address field 230 is 8 bytes and indicates the address of the frame destination, and the transmission time field 240 is 12 bytes and indicates the transmission time of the frame. The frame length field 250 is 6 bytes and indicates the length of the data, and the data field 260 following the frame length field 250 has variable length according to the data to be transmitted. The frame end field 270 is 1 byte and indicates the end of the frame, and the LRC field 280 is 1 byte for detecting data transmission errors in the frame.

Referring to FIG. 1, the kiosk 300 includes a touch screen 310, a network interface unit 320, a storage unit 330, a public information monitor 340, a first controller 350, a television reception card 410, an advertisement monitor 420, and a second controller 430.

As shown in FIG. 2, the kiosk 300 comprises a main body 460 having a shape of a rectangular column with a frontward projected lower portion. The kiosk 300 is provided with the public information monitor 340 and advertisement monitor 420 at respective upper and lower portions of a front wall thereof. The touch screen 310 is arranged at the upper surface of the projected lower portion of the main body 460 perpendicularly adjacent to the lower side of the advertisement monitor 420.

Referring to FIG. 1 again, the touch screen 310 displays a graphic user interface listing a plurality of selection items in order for the user to select an item by touching the item on the touch screen 310 under control of the first controller 350. That is, the touch screen 310 displays information items such as travel schedules road maps, and etc. such that detail information on each item is displayed on the public information monitor 340 when the item is selected, and displays television broadcasting channel and sound volume buttons enabling the user to select a channel and to adjust sound volume of the motion graphic user interface displaying on the advertisement monitor 420.

If the channel or volume button is selected by the user, a selection signal is generated and transmitted to the first controller 350 so as to change channel or adjust sound volume.

The network interface unit 320 includes a networking means like a modem for enabling the kiosk 300 so as to communicate with the server system 100 through the Internet 500The data received from the server system 100 are temporally stored in the storage unit 330 such as a RAM or a hard disc under control of the first controller 350.

The public information monitor 340 is used for displaying the information retrieved from the storage unit 330 in response to the user's item selection on the touch screen 310 under the control of the first controller 350.

The first controller 350 controls the touch screen 310 so as to display the various public information items and the channel and volume adjusting buttons on the touch screen 310, receives the user input signal from the touch screen 310, and performs an operation in response to the user input signal. Further, the first controller 350 communicates with the server system 100 through the network interface unit 320 over the Internet 500. The first controller 350 further controls the public information monitor 340 to display various commercial advertisement and public information provided from the server system 100.

The television reception card 410 typically has a tuner (not shown) and a memory (not shown). The card 410 receives a broadcasting signal from a broadcast source such as a broadcast station through a transmission channel under the control of the second controller 430. The received broadcasting signal is an analog signal such that the analog signal is converted into a digital signal for a personal computer (PC) by the television reception card 410. The digital television signal is temporarily stored in the video memory 440.

The digital television signal stored in the video memory 440 is coordinated with advertisement signal from the storage unit 330 to be displayed on the advertisement monitor 420 under the control of a graphic controller 450.

The advertisement monitor 420 is used as a PC monitor for displaying the signal coordinated by the video memory 440 under the control of the graphic controller 450.

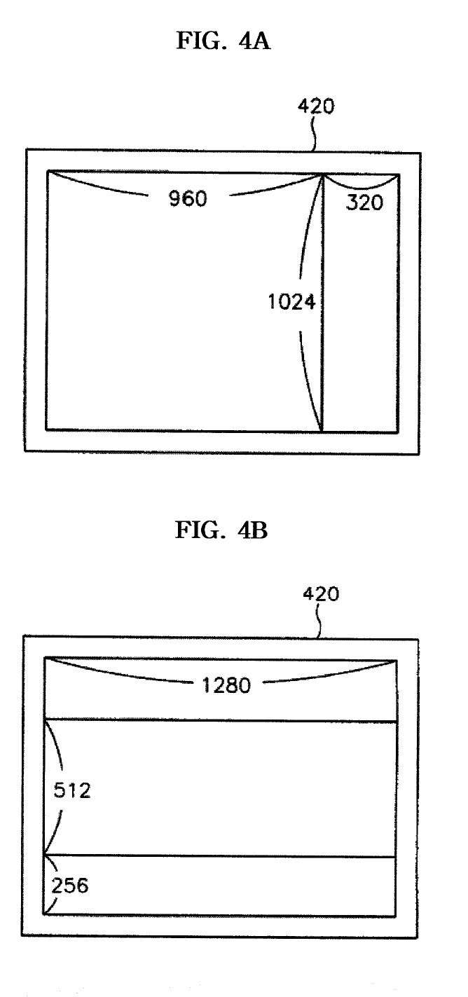

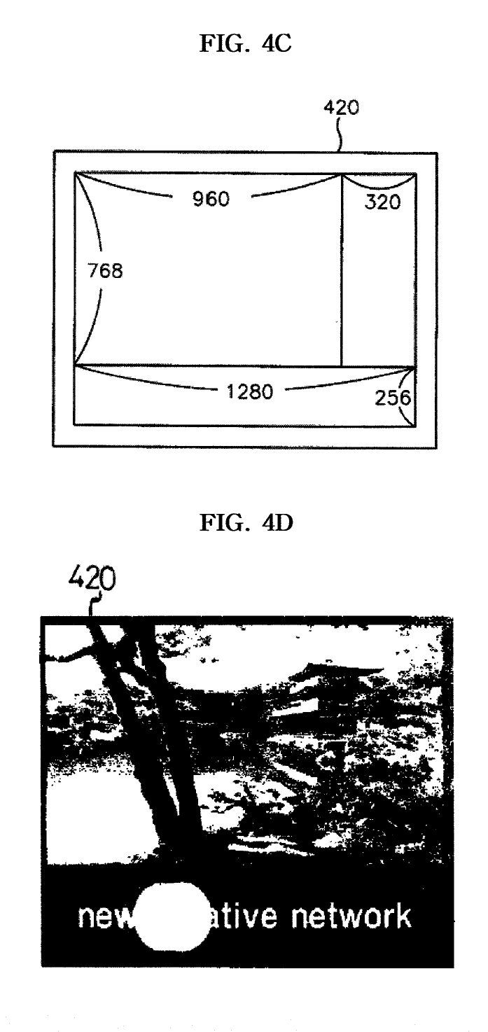

FIGS. 4a to 4d are views showing a divided screen for simultaneously displaying the broadcasting signal coordinated with the advertisement signal through a screen division process on the advertisement monitor 420.

As shown in FIGS. 4a to 4d, the graphic controller 450 controls such that the advertisement screen simultaneously displays two or more images on the screen divided into two or more frames through the screen division process, such that a main frame displays the digital television signal and the others displays advertisements. For example, in the advertisement monitor 420 of FIG. 4a, the screen with a resolution of 1280*1024 is divided into two frames with resolutions of 960*1024 and 320*1024, respectively. Referring to FIG. 4b, the screen with a resolution of 1280*1024 is divided into three frames with resolutions of 1280*256, 1280*512, and 1280*256, respectively. Referring to FIG. 4c, the screen with a resolution of 1280*1024 is divided into three frames with resolutions of 960*768, 320*768, and 1280*256, respectively. Referring to FIG. 4d, the screen divided into two frames with respective resolutions of 1280*768 and 1280*256 displays the television broadcasting signal on the upper frame and the advertisement signal on the lower frame at the same time. For dividing the screen of the advertisement monitor 420, the graphic controller 450 controls the television reception card 410 such that the television reception card 410 adjusts horizontal and vertical resolutions of the digital television signal and advertisement signal from the storage unit 330. The resolution-adjusted television and the advertisement signals are stored in the video memory 440. Thereby, the television broadcasting signal coordinated with the advertisement signal can be displayed on the monitor 420 as shown in FIG. 4d. In FIGS. 4a to 4d, the screen of the monitor 420 is divided into two or three frames as examples, however, the screen can be divided into more frames without affecting the functioning of this invention.

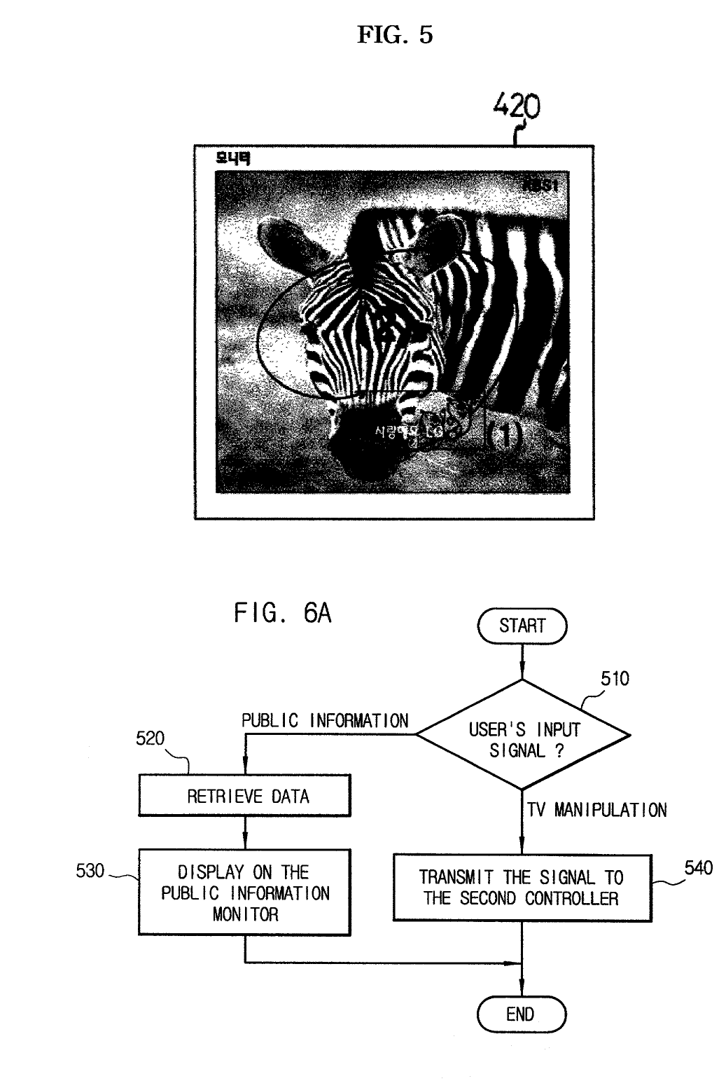

FIG. 5 is an exemplary view of a screen for illustrating how the advertisement signal is overlapped with the broadcasting image on the monitor 420. Referring to FIG. 5, characters are displayed with the television broadcasting image displayed on a full screen or divided screen of the monitor 420 of FIG. 4, and the advertisement image can be a specific character, a logo, or a mark. The overlapped advertisement image can be set so as to move along a predetermined path by drawing a shape of circle or zigzag on the television broadcasting image. Such an overlapping technique, as is well known in the field, can be obtained by inserting video characters of the advertisement signal in any parts of the horizontal and vertical lines of the digital television signal which is stored in the video memory 440, and varying x and y coordinates of the inserted horizontal and vertical lines according to the preset path. In this case, the overlapping technique is regarded to be progressed by one step from a conventional advertisement just displayed on a monitor. In the overlapped advertisement image, a predetermined character appears at any one side or at the center of the screen to display a desired advertisement image, and then disappears from the screen, during a watching of various broadcast channels by the user. Thereby, the user experiences an enhanced advertising effect, and is not bored by the advertisement image.

The second controller 430, which can be realized as a microcomputer similarly to the first controller 350, controls the television reception card 410 so as to change transmission channel to receive a broadcasting image of a desired broadcasting channel, and to adjust the volume level of the received broadcasting channel, in response to the channel and volume adjusting signal received from the first controller 350. Further, the second controller 430 controls the graphic controller 450 to coordinate the broadcasting image received through the television reception card 410 with the advertisement image or characters from the storage unit 330 in the video memory so as to display the coordinated image on the advertisement monitor 420.

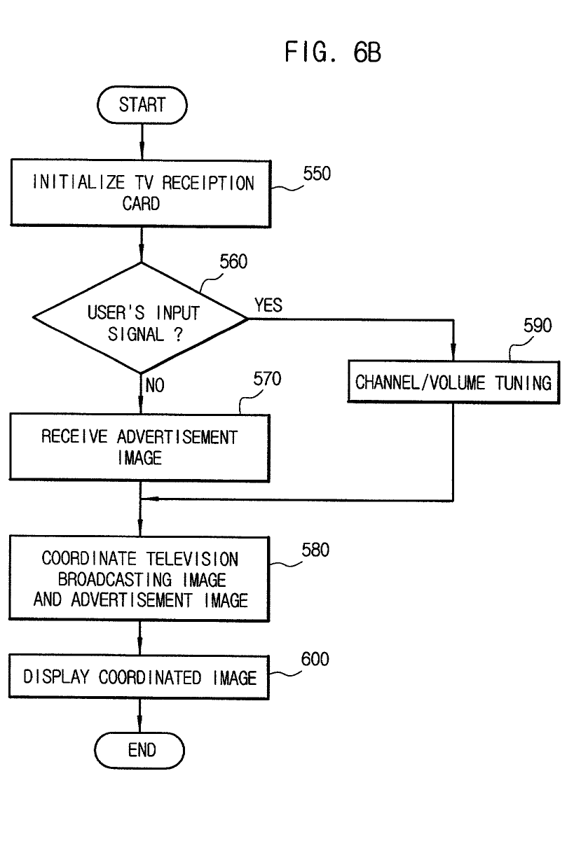

The operation of the above-structured kiosk system will be described in detail in accompanying with FIGS. 6a and 6b hereinafter.

FIGS. 6a and 6b are flowcharts illustrating the respective control processes of the first and second controllers 350 and 430.

Referring to FIGS. 6a and 6b, the control operation performed in the state of receiving the public information and the advertising file according to the timing schedule preset by the server system 100 through the Internet 500 is described.

Referring to FIG. 6a, the first controller 350 receives the user input signal generated by the touch screen 310 and determines whether the user input signal is related to the public information or the television broadcasting at step 510. If it is determined that the user input signal is related to the public information, the first controller 350 retrieves in the storage unit 330 for retrieving requested information at step 520 and displays the retrieved public information on the public information monitor 340 at step 530.

On the other hand, if it is determined the user input signal is related to a television manipulation, for example, a channel and volume adjustment at step 510, the first controller 350 transmits the user input signal to the second controller 430 at step 540.

Referring to FIG. 6b, the second controller 430 initializes the television reception card 410 when the system is powered on at step 550, and then determines whether or not the user input signal related to the television manipulation has been received from the first controller 350 at step 560. If it is determined that the user input signal related to the television manipulation is not received, the second controller 430 controls such that the advertisement image from the server system 100 and the broadcasting image from the television reception card 410 through the previously selected (or tuned) channel are transmitted to the video memory 440 at step 570.

Next, the broadcasting image and the advertisement image stored in the video memory 440 are coordinated together through the screen division process under the control of the graphic controller 450 at step 580. Consequently, the coordinated screen is displayed on the monitor 420 at step 600.

At step 560, if the television manipulation signal such as channel and volume adjusting signal is received from the first controller 350, the second controller 430 controls the television reception card 410 so as to change the channel or adjust the volume according to the user's manipulation at step 590. In this case, the broadcasting image received through the changed channel is coordinated with the advertisement signal at step 580, and is displayed on the divided screen of the monitor 420.

As described above, the present invention provides a kiosk system for simultaneously centrally controlling a plurality of kiosks through the Internet. The present invention is advantageous in that the kiosks with a plurality of monitors make it possible to display the public information on one monitor, and at the same time, display a television broadcasting image together with an advertisement image on another monitor. The kiosk system employing the coordinated displaying technique according to the present invention is advantageous in that it allows the user to concentrate on one monitor, thus maximizing an advertising effect through the user's concentration on the monitor relative to the conventional kiosk system having two separate monitors as a television monitor and an advertisement monitor that disperses user's attention.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A kiosk system centrally controlled through the Internet, comprising:
a database for storing public information and advertisement image;
a server for reading the public information and the advertisement image stored in the database according to a preset timing schedule and transmitting them through the Internet; and
a plurality of kiosks for receiving the public information and the advertisement image from the server through the Internet, a broadcast signal through wireless channels from broadcasting stations, and displaying the advertisement image together with television broadcasting image on a monitor, such that the advertisement image is movably floating along a preset path on the broadcasting image.

2. The kiosk system of claim 1, wherein each kiosk comprises:
a memory for temporarily storing the public information and the advertisement image received from the server;
a first controller controlling so as to store the public information and the advertisement image received from the server through the Internet in the memory, and display the public information retrieved from the memory in response to a user request;
a first monitor for displaying the public information under the control of the first controller;
television broadcast reception means for selecting one of broadcasting channels received from broadcasting source;
graphic control means for coordinating the broadcasting image received through the selected channel with an advertisement image retrieved from the memory;
a second monitor for displaying a coordinated image from the graphic control means; and
a second controller communicating with the first controller for controlling the television broadcast reception means so as to select the channel according to the user input signal received from the first controller, and controlling the graphic control means to simultaneously display the broadcasting image coordinated with the advertisement signal on the second monitor.

3. The kiosk system of claim 2 further comprising a touch screen for providing a graphic user interface with a plurality of selection items in order for a user to select service items using a touch screen and to generate a user selection signal,
wherein the first controller composes the graphic user interface on the touch screen, and displays public information retrieved from the memory in response to the user selection signal on the first monitor.

4. The kiosk system of claim 2, wherein the graphic control means comprises:
a video memory for coordinating the broadcasting image with an advertisement image retrieved from the memory; and
a graphic controller for controlling the video memory so as to generate picture of the broadcasting image coordinated with the advertisement image.

5. The kiosk system of claim 4, wherein the graphic controller divides a screen of the first monitor into a plurality of frames, and displays the broadcasting image and the advertisement image on respective corresponding frames of the screen.

6. A kiosk system centrally controlled through the Internet, comprising:
a plurality of kiosks;
a database for storing public information and an advertisement image; and
a server for communicating with the kiosks through the Internet and transmitting the public information and the advertisement image stored in the database in unit of frame according to a preset timing schedule to the kiosks,
wherein the frame is provided with a frame start, frame code, destination address, transmission time, frame length, data, frame end, and LRC fields.

7. A kiosk system of claim 6 wherein the frame start field is 1 byte and indicates start point of the frame.

8. A kiosk system of claim 6 wherein the frame code field is 5 bytes and indicates a kind of the frame.

9. A kiosk system of claim 6 wherein the destination address field is 8 bytes and indicates the address of the destination of the frame.

10. A kiosk system of claim 6 wherein the transmission time field is 12 bytes and indicates the transmission time of the frame.

11. A kiosk system of claim 6 wherein the frame length field is 6 bytes and indicates the length of the data.

12. A kiosk system of claim 6 wherein the data field following the frame length field has variable length according to the data to be transmitted.

13. A kiosk system of claim 6 wherein the frame end field is 1 byte and indicates the end of the frame.

14. A kiosk system of claim 6 wherein the LRC field 280 is 1 byte for detecting data transmission errors in the frame.

15. A kiosk system of claim 6 wherein each kiosk comprises:
a memory for temporarily storing the public information and the advertisement image received from the server;
a network interface unit for connecting the kiosk to the server so as to transmit and receive the public information and the advertisement image in unit of frame;
a touch screen for providing a graphic user interface with a plurality of selection items in order for a user to select service items using the touch screen and to generate a user selection signal;
a first monitor for displaying the public information in response to the user input signal;
a first controller for controlling the memory to store the public information and the advertisement image by communicating with the server through the Internet, and composing the graphic user interface on the touch screen, and thereby displaying the public information requested by the user inputting the selection signal and is retrieved from the memory in response to the user selection signal on the first monitor;
television broadcast reception means for selecting a channel of a broadcasting image received from a broadcasting source through a transmission channel;
graphic control means for coordinating the broadcasting image received through the channel selected by the television broadcast reception means with an advertisement image retrieved from the memory;
a second monitor for displaying a coordinated image from the graphic control means; and
a second controller communicating with the first controller for controlling the television broadcast reception means so as to select the channel according to the user input signal received from the first controller, and controlling the graphic control means to display the broadcasting image coordinated with the advertisement signal on the second monitor.

16. A kiosk system centrally controlled through the Internet, comprising:
a database for storing public information and an advertisement image;
a server for reading the public information and the advertisement image stored in the database according to a preset timing schedule and transmitting them through the Internet; and
a plurality of kiosks for receiving the public information and the advertisement image from the server through the Internet, receiving broadcasting image through wireless channel, and displaying them on a screen.

17. The system as set forth in claim 16, wherein the each kiosk comprises:
a memory for temporarily storing the public information and the advertisement image received from the server;
a first controller for controlling so as to store the public information and the advertisement image received from the server through the Internet in the memory, and display the public information retrieved from the memory in response to a user request;
a first monitor for displaying the public information under the control of the first controller;
television broadcast reception means for selecting one of broadcasting channels received from broadcast sources;
graphic control means for coordinating the broadcasting image received through the channel selected by the television broadcast reception means with an advertisement image retrieved from the memory;
a second monitor for displaying a coordinated image from the graphic control means; and
a second controller communicating with the first controller for controlling the television broadcast reception means so as to select the channel according to the user input signal received from the first controller, and controlling the graphic control means to simultaneously display the broadcasting image coordinated with the advertisement image on the second monitor.

18. The system as set forth in claim 17, further comprising a touch screen for providing a graphic user interface with a plurality of selection items in order for a user to select items using a touch screen and generate a user input signal corresponding to an item selected on the graphic user interface,
wherein the first controller composes the graphic user interface on the touch screen, and retrieves requested public information from the memory in response to the user input signal, and displays the retrieved public information on the first monitor.

19. The system as set forth in claim 17, wherein the graphic control means includes:
a video memory for coordinating the broadcast program with an advertisement image retrieved from the memory; and
a graphic controller for controlling the video memory to generate a picture of the broadcasting image coordinated with the advertisement image.

20. The system as set forth in claim 19, wherein the graphic controller divides a screen of the second monitor into a plurality of frames, and displays the broadcasting image and the advertisement image on respective corresponding frames of the screen.

21. The system as set forth in claim 19, wherein the graphic controller receives the public information and the advertising image from the server through the Internet, and receives a broadcast signal through wireless channel, displays the advertisement image together with the broadcasting image such that the advertisement image is movably floating along a preset path on the broadcasting image.

22. A kiosk system centrally controlled through the Internet, comprising:
a database for storing public information and an advertisement image;
a server for reading the public information and the advertisement image stored in the database according to a preset timing schedule and transmitting them through the Internet; and
a plurality of kiosks, each having a touch screen displaying a graphic user interface listing a plurality of selection items in order for a user to select items by touching the items and generating a user input signal corresponding to the item selected on the graphic user interface, the kiosk also receiving the public information and the advertisement image from the server through the Internet, receiving a broadcasting image through wireless channels, and coordinating the broadcast image with the advertisement image such that the coordinated image is displayed on a monitor.

23. The system as set forth in claim 22, wherein the kiosk comprises:
a memory for temporarily storing the public information and the advertisement image received from the server;
a first controller controlling so as to store the public information and the advertisement image received from the server through the Internet in a memory, retrieve the public information from the memory, compose a graphic user interface on the touch screen such that items listed on the touch screen indicates corresponding public information in the memory, and display the public information retrieved from the memory in response to the user input signal received through the touch screen on a screen;
a first monitor for displaying the public information under the control of the first controller;
television broadcast reception means for selecting one of broadcasting channels received from broadcasting sources;
graphic control means for coordinating the broadcasting image received through the selected channel with an advertisement image retrieved from the memory;
a second monitor for displaying a coordinated image from the graphic control means; and
a second controller communicating with the first controller for controlling the television broadcast reception means so as to select the channel in response to the user input signal received from the first controller, and controlling the graphic control means to simultaneously display the broadcasting image coordinated with the advertisement image on the second monitor.

24. The system as set forth in claim 23 wherein the graphic control means includes:
a video memory for coordinating the broadcasting image with the advertisement image retrieved from the memory; and
a graphic controller for controlling the video memory to generate a picture of the broadcasting image coordinated with the advertisement image.

25. The system as set forth in claim 24, wherein the graphic controller divides a screen of the second monitor into a plurality of frames, and displays the broadcasting image and the advertisement image in respective corresponding frames of the screen.

26. The system as set forth in claim 25, wherein the graphic controller displays the advertisement image together with the broadcasting image such that the advertisement image is movably floating along a preset path on the broadcasting image frame.

27. A kiosk system centrally controlled through the Internet, comprising:
a database for storing public information and an advertisement image;
a server for reading the public information and the advertisement image stored in the database according to a preset timing schedule and transmitting them through the Internet; and
a plurality of kiosks for receiving the public information and the advertisement image from the server through the Internet, receiving a broadcasting image through wireless channels, and coordinating the broadcasting image with the advertisement image so as to generate coordinated image,
wherein the each kiosk include:
a memory for temporarily storing the public information and the advertisement image received from the server;
a first monitor for displaying the public information according to user manipulation;
a touch screen for providing a graphic user interface with a plurality of selection items to be selected by a user using a touch screen technique, and generating a user input signal corresponding to an item selection on the graphic user interface;
a first controller controlling so as to store the public information and the advertisement image received from the server through the Internet, and compose the graphic user interface on the touch screen, and display the public information retrieved from the memory in response to the user input signal from the touch screen on the first monitor,
television broadcast reception means for selecting a channel of a broadcast program received from a broadcast program source through a transmission channel;
graphic control means having a video memory for coordinating the broadcasting image received through the channel selected by the television broadcast reception means with an advertisement image retrieved from the memory, and a graphic controller for controlling the graphic memory so as to divide a screen of a second monitor into a plurality of frames in the case of displaying the broadcast image coordinated with the advertisement image, thus display the broadcasting image and the advertisement image in the respective corresponding frames of the screen, and enable the advertisement image to be overlapped on the broadcasting image such that the advertisement image is movable floating along a preset path on the frame of the broadcasting image;
the second monitor for displaying a coordinated image signal from the graphic control means; and
a second controller communicating with the first controller for controlling the television broadcast reception means so as to select the channel according to the user input signal received from the first controller, and controlling the graphic control means to simultaneously display the broadcasting image coordinated with the advertisement image on the second monitor.
